(19) United States
(12) Patent Application Publication
(10) Pub. No.: US 2017/0220971 A1
(43) Pub. Date: Aug. 3, 2017

(54) SOCIAL NETWORKING DATA PROCESSING SYSTEM BASED ON COMMUNICATION FRAMEWORK WITH SUBJECT MATTER EXPERTS TO IMPROVE WEB ANALYTICS ANALYSIS

(71) Applicant: International Business Machines Corporation, Armonk, NY (US)

(72) Inventors: Alberto Giammaria, Austin, TX (US); Chunhui Y. Higgins, Raleigh, NC (US); William P. Higgins, Durham, NC (US); Christopher A. Maul, Wake Forest, NC (US); John H. Walczyk, III, Raleigh, NC (US); Ke Zhu, Cary, NC (US)

(21) Appl. No.: 15/008,831

(22) Filed: Jan. 28, 2016

(51) Int. Cl. G06Q 10/06; G06Q 50/00; G06Q 10/10; H04L 29/08; G06F 17/30

(52) U.S. Cl. CPC G06Q 10/06393; H04L 67/306; G06F 17/3053; G06Q 10/105; G06Q 50/01; G06F 17/3097

(57) ABSTRACT

A social networking-based web analytics data processing system having subject matter expert (SME) cognitive capability includes a data report dashboard module, and a rating module. The data report dashboard module includes an electronic hardware controller to generate an initial web analytics data report and to generate at least one inquiry associated with at least one abnormality included in the initial web analytics data report. The rating module detects at least one of a positive ranking and a negative ranking applied to a comment submitted by a user in reply to the at least one inquiry. The social networking-based web analytics data processing system further includes a subject matter expert (SME) identification module that identifies a SME based on at least one of social networking information, community expertise ranking and project stakeholder recognitions.

### BACKGROUND

The present invention relates to business insights mining systems, and more specifically, to a web analytics business data processing system with cognitive capabilities to recognize subject matter experts (SME) in order to mine the more complete and accurate business insights.

The development of web analytics systems has become increasing popular for improving and maximizing corporate and personal eCommerce ventures. Conventional web analytics systems typically provide only the web analytics activities (such as users, systems and marketing activities), data reports, or dashboard metrics. However, the true value of web analytics is to gain business insights based on user-behavior data. In addition, traditional business schemes typically employ human analysts to study the data and generate a business actionable insight analysis report for business executives. However, these analysts typically lack the technical background associated with the web analytics implementation, as well as the marketing and sales strategies. Therefore, it is not practical to rely on only the reports prepared by the human analysts that are domain experts in various functional areas.

### SUMMARY

According to a non-limiting embodiment, a social networking-based web analytics data processing system having subject matter expert (SME) cognitive capability includes a data report dashboard module, and a rating module. The data report dashboard module includes an electronic hardware controller to generate an initial web analytics data report and to generate at least one inquiry associated with at least one abnormality included in the initial web analytics data report. The rating module detects at least one of a positive ranking and a negative ranking applied to a comment submitted by a user in reply to the at least one inquiry. The social networking-based web analytics data processing system further includes a subject matter expert (SME) identification module that identifies a SME based on at least one of social networking information, community expertise ranking and project stakeholder recognitions.

According to another non-limiting embodiment, a method of improving accuracy of a web analytics business report comprises generating an initial web analytics data report, and generating at least one inquiry associated with at least one abnormality included in the initial web analytics data report. The method further comprises detecting at least one of a positive ranking and a negative ranking applied to a comment submitted by at least one user in reply to the at least one inquiry. The method further comprises identifying a subject matter expert (SME) among the at least one user based on the positive ranking, and updating the web analytics data report based on an input from the SME to improve the accuracy of the web analytics business report.

According to yet another non-limiting embodiment, a computer program product controls an electronic device to improve accuracy of a web analytics business report. The computer program product comprises a computer readable storage medium having program instructions embodied therewith. The program instructions are executable by an electronic computer processor to control the electronic device to perform operations comprising generating an initial web analytics data report, and generating at least one inquiry associated with at least one abnormality included in the initial web analytics data report. The operations further include detecting at least one of a positive ranking and a negative ranking applied to a comment submitted by at least one user in reply to the at least one inquiry. The operations still further include identifying a subject matter expert (SME) among the at least one user based on the positive ranking, and updating the web analytics data report based on an input from the SME to improve the accuracy of the web analytics business report.

Additional features are realized through the techniques of the present invention. Other embodiments are described in detail herein and are considered a part of the claimed invention. For a better understanding of the invention with the features, refer to the description and to the drawings.

### BRIEF DESCRIPTION OF THE DRAWINGS

FIG. 1 is a block diagram illustrating a social networking-based web analytics data processing system 100 according to a non-limiting embodiment;

FIG. 2 is a flow diagram illustrating a method of improving the accuracy of a web analytics business report based on SME identification according to a non-limiting embodiment; and

FIG. 3 is a flow diagram illustrating a method of improving the accuracy of a web analytics business report based on SME identification according to another non-limiting embodiment.

### DETAILED DESCRIPTION

Various non-limiting embodiments of the invention provide a “social network” based communication framework for web analytics. At least one embodiment provides subject matter expert (SME) cognition by utilizing the social network information, and identifying user roles and specialties associated within the subject matter and identifying and recommend the experts of the subject matter, finding the connectors which can recommend the experts using the social network information, project profile information, and community information.

In at least one, the “social network” based communication framework for web analytics is configured to generate the most complete and accurate web analytics intelligent business report solution. In this manner, various issues including, but not limited to, incomplete business reports, data analysis reporting without actionable insights, limitation of analysts' knowledge of technical implementation and marketing and sales plans and actions may be resolved.

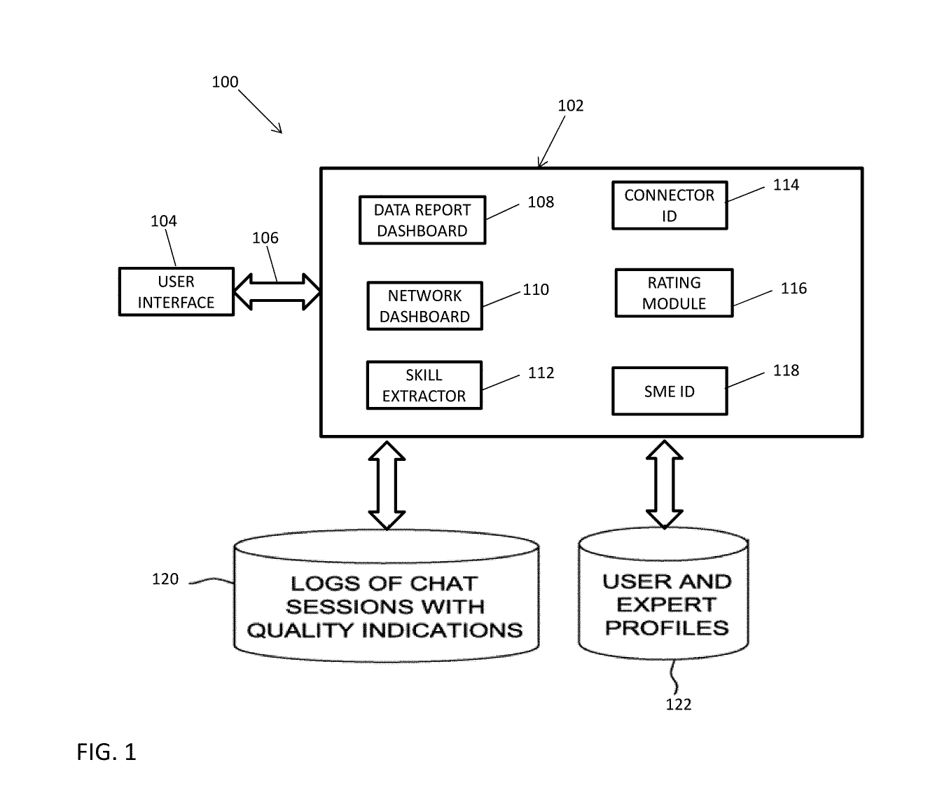

With reference now to FIG. 1, a social networking-based web analytics data processing system 100 is illustrated according to a non-limiting embodiment. The social networking data processing system 100 is operated according to a communication framework based on subject matter experts (SMEs) to improve web analytics analysis. The system 100 includes an electronic hardware processor 102 that communicates with a user interface 104 via a communication device 106. The user interface 104 may be installed on an electronic device (e.g., mobile phone, laptop computer, tablet computer, etc.) controlled by a respective user.

The processor 102 includes various control modules operating under the control of an electronic hardware controller configured to execute computer readable instructions stored in memory. In this manner, the various control modules are configured to utilize the social network information, identify user roles and specialties associated within the subject matter, and identify and recommend one or more SMEs corresponding to the subject matter. In this manner, the system 100 can recommend one or more SMEs using social network information, web page information, etc., in order to generate the most complete and accurate web analytics intelligent business report solution. Accordingly, various deficiencies found in traditional web analytics reports such as, for example, incomplete business report, data only and no insights reporting, limitation of analysts knowledge of technical implementation and marketing plans, sales plans, etc., may be eliminated.

The processor 102 includes a data report dashboard module 108, a network dashboard module 110, a skill extractor module 112, a connector identification (ID) module 114, a rating module 116, and a SME ID module 118. Each of the modules 108-118 may be in signal communication with one another such that data may be exchanged. In addition, the modules 108-118 may be in signal communication with one or more databases such as, for example, a chat log database 120 and a user/SME profile database 122.

The invention is not limited to any particular processor, interface or storage device. Elements illustrated as singular in the drawing might, in implementation, actually extend over plural devices; while elements illustrated as separate in the drawing might be incorporated in a single device. One or more of the modules 108-118 described herein may be implemented as hardware or software. As mentioned above, the hardware modules may each include an electronic hardware controller configured to execute various operations according to computer readable instructions stored in memory. Software may be stored internally to the processor or externally. Databases can be implemented in any suitable format, as a matter of design choice.

The data report dashboard module 108 is configured to automatically generate web analytics data reports based on user activities performed on a respective website. The data reports include, but are not limited to, data regarding user visits, unique visitors, new visit percentages, visit-to-purchase conversion rate, bounce rate, exit rate, visit duration, pages/visits, etc.

In addition, the data report dashboard module 108 may generate a web analytics intelligent business report that includes the most important business insights input with linkages to the details of data and rationales behind it. When there are no rated top answers, the system 100 may rely on a confidence level assigned to the answers provided by identified SMEs as discussed in greater detail below. In at least one embodiment, the confidence level is based on a number of previously submitted answers/comments ranked as ideal answers that resolve inquiries associated with previously generated business reports.

The data report dashboard 108 module is also configured to identify abnormalities in the data report, and automatically generate questions related to business insights. Abnormalities include excessive changes in trends such increases or decreases in webpage visits, for example. An excessive trend may be detected by comparing webpage data (e.g., visits) to a threshold value. Excessive trends may also be detected when trend data exceeds a threshold value during a predetermined time period. For example, an abnormality may be identified as excessive webpage visits occurring during a time period (e.g., 1 hour, 1 day, 1 week, etc.).

The network dashboard module 110 may act as a chat control and also enables users with various roles to provide insights of the web analytics business report. In addition, the network dashboard module 110 allows users involved in a chat session to rate comments input by other users in real-time. Thus, as comments from one or more users are submitted in reply to questions or inquiries concerning the data report, other users may rank the comments as relevant or correct as they are submitted. In at least one embodiment, an alert such as, for example, a sound alert, graphical indicator, etc., may indicate a positive and/or negative ranking applied to a respective user. In this manner, the users or participants of a chat session may be aware of the ranking associated with a particular user's comments or answers.

The skill extractor module 112 may extract terms from chat or message sessions so as to determine the roles of the users participating in the session. These roles may be assigned to a user's profile and stored in the profile database 122 for future reference. Thus, when a similar question arises in the future, the SME ID module 118 may match a question to previously stored profiles having matching roles to identify the proper SME.

The skill extractor module 112 may also utilize social networking information to identify specialties associated with a particular the subject matter. The various social networking information includes, but is not limited to, profile information added by users to their respective social network profiles, professional website information, technical paper publication data, etc. In at least one embodiment, the skill extractor module 112 can link social networking/media data to the business results to determine which users have the most impact on the business results.

For example, the skill extractor module 112 may use web analytics to measure the most business result influencers, and utilizes social network site profiles to identify roles and expertise. In at least one embodiment, the skill extractor module 112 mines social media results, and correlates the social media results to the business results. This can be performed in various different manners as discussed in greater detail below.

In at least one embodiment, an HTTP header extraction technique is used to identify roles of a user. For instance, the skill extractor module 112 may extract an HTTP link in a user's social media post. In this manner the skill extractor module 112 can directly link the user's social media post to a business result.

A second method is a timing-based approach. For instance, a user may submit a post on a social media site referring to a particular site. The business results may be monitored for a time period following the user's post to determine if the user is influence maker. For example, if an increase in business results occurs within a time period (e.g. one hour) following the users post, then the user is more likely an influence maker. If a user posts something on social media referring to the site, and it does not increase the business results then the user is less likely to be an influence maker. Over time a higher confidence score may be generated, and based on the confidence score a determination can be made as to whether a user's social media posts will influence the business results.

According to at least one embodiment, an aggregated confidence score may be calculated based on a plurality of weighted confidence criteria. The confidence criteria includes, but is not limited to, an expertise confidence rating corresponding to a particular domain or area of interest, voting scores submitted by analysts that are experts in a particular domain or area of interest, voting scores submitted by analysts that are non-experts in a particular domain or area of interest, and previously stored insights or comments flagged as ideal or correct answers submitted in connection with previous data reports.

In at least one embodiment, the network dashboard module 112 may obtain the confidence levels assigned to each user submitting comments/answers in a chat session, and display or overlay the confidence score along with a respective comment. In this manner, the system 100 may convey to users participating in a chat the confidence level associated with each submitted comment or answer. For example, based on a particular user's answers and the value that the community assigned to the answers in the past, the system 100 may display a confidence percentage indicating the likeness that the user is or is not is an expert in a particular domain (e.g., 0% indicating no expertise and 100% a full expert).

In addition, the skill extractor module 112 is further configured to extract web site usage information based on social media data and web site runtime logs. In at least one embodiment, the skill extractor module 112 correlates the web site access log and social media results into graph data based on website URL layouts. Based on the graph data, the skill extractor module 112 determines user activities by filtering semantic tags from referrer social media link to calculate network flow by time, user profile attributes, and website URL scheme.

In at least one embodiment, business analysts may leverage the network flow data to determine various business results. For instance, the business analysts can apply various filters to the network flow data. The filters include, but are not limited to, time range, referrer tag, and source address. Analysts may also manually include their own input data to further filter the network flow data. The manual input data includes, but is not limited to, invalid access information and invalid source address information. In this manner, the analysts may remove additional noise from the network flow data so as to improve the accuracy of the discovery results.

In addition, the skill extractor module 112 is configured to determine and identify roles of the one or more of the users based on the social network information and other profession network information such as professional webpage bio information, etc. The roles of users and/or analysts may be dynamically learned and stored in the profile data base 122 for future reference.

The connector ID module 114 is configured to identify the connector (i.e., contact person) who is aware of the proper SMEs capable of answering questions in specific fields/topics. The connector may also recommend the SME of particular topic, using the social network information. The connector ID module 115 may also determine the most relevant “connectors” mostly likely to answer questions to the data reports especially when there are no satisfying answers.

The rating module 116 is configured to detect ratings assigned to one or more users' comments or answers. For instance, the rating module 116 may compare a number of positive ratings submitted by users to a rating threshold. When the number of positive ratings exceeds the threshold, the rating module 116 determines that a particular comment as the most valuable insight. In addition, a number of most insightful comments provided by a particular user may be monitored and counted. As the number of insight comments provided by a user increases, the rating of the user increases.

In at least one embodiment, given a new or existing user with a new question on a topic, experts enrolled in that topic may be ranked in decreasing order of potential match, taking into account: (a) past interactions and ratings if available, and (b) internal information about members such as job profiles, description of project engagements etc.

The SME ID module 118 is configured to identify one or more users as an SME based on the information provided by one or of the modules 108-116 and/or the data stored in the profile database 122. For example, the SME ID module 118 may identify one or more users as SMEs in the domain or subject-area of the inquiry based on the rankings indicated by the rating module 116 and/or the roles identified by the skill extractor module 112. In at least one embodiment, the SME ID module 118 may monitor the ratings of one or more users assigned by the rating module 116 and dynamically determine one or more SMEs among the users. That is, as the ratings assigned to a user increases or decrease, the SME ID module 118 may dynamically identify one or more of the users as a SME with an expertise in a particular area or domain. The SME ID module 118 may then create a profile of an SME in the SME profile database 122 for future reference. If a profile exists, then the SME ID module 118 may update the current profile stored in the profile database 122. In addition, the SME ID module 118 may identify the expertise of a user based on their respective rating. That is, users with an increased rating score are weighed more heavily as an expert than users with lower rating scores.

In at least one embodiment, the SME ID module 118 automatically generates a notification signal in response to determining a match between data reports and identified roles/expertise of one or more users and/or analysts. The notification signal may in turn generate a notification to a respective user/analyst. The notification may include, but is not limited to, a graphical alert, audio alert, physical alert, etc. For instance, the notification signal may force an electric device (e.g., a mobile device) of a user to vibrate so as to notify the user that they have been identified as a SME most capable of providing an answer to a question or inquiry in connection with a particular data report.

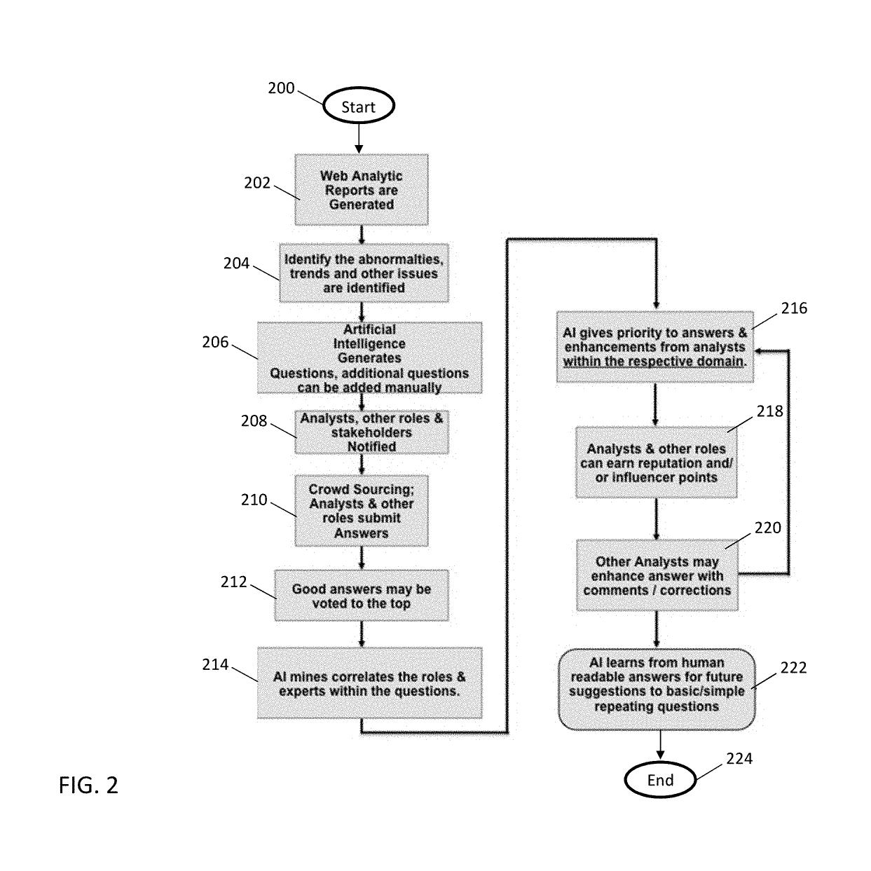

Turning now to FIG. 2, a method of improving the accuracy of a web analytics business report based on SME identification is illustrated according to a non-limiting embodiment. The method begins at operation 200, and at operation 202 a web analytics report is generated. At operation 204, one or more abnormalities of the report are identified. The abnormalities include, for example, uncharacteristic data trends such as excessive webpage visits during a time period (e.g., 1 hour, 1 day, 1 week, etc.). At operation 206, questions or inquiries related to the abnormalities are generated. In at least one embodiment, the inquiries are automatically generated by, for example, a data report dashboard module. At operation 208, users of the system are notified of the inquiries. The system users include, for example, business analysts, technicians, managers, and stakeholders.

At operation 210, a crowd sourcing procedures is performed. The crowd sourcing includes requesting the users to submit answers or comments to the inquiries. At operation 212, users submit votes to the answers/inquiries. In at least one embodiment, answers/inquiries with the highest votes are dynamically moved upward and displayed at the top of the answer list or chat session display. At operation 214, the system determines roles and expertise of the users and correlates the roles and expertise with the inquiries and answers. At operation 216, the system prioritizes answers from users within a respective domain. At operation 218, users are assigned scores based on the submitted votes and user inputs indicating whether the submitted answers/comments resolve a respective inquiry. At operation 220, other users outside a respective domain or in a technical field unrelated to the inquiry submit answers, comments, and/or corrections to the previously submitted answers/comments. When there are no other additional comments, the method proceeds to operation 222 where the system actively identifies one or more users and an SME with respect to the current inquiry. The identified SMEs and their respective roles are stored in a database for future reference, and the method ends at operation 224.

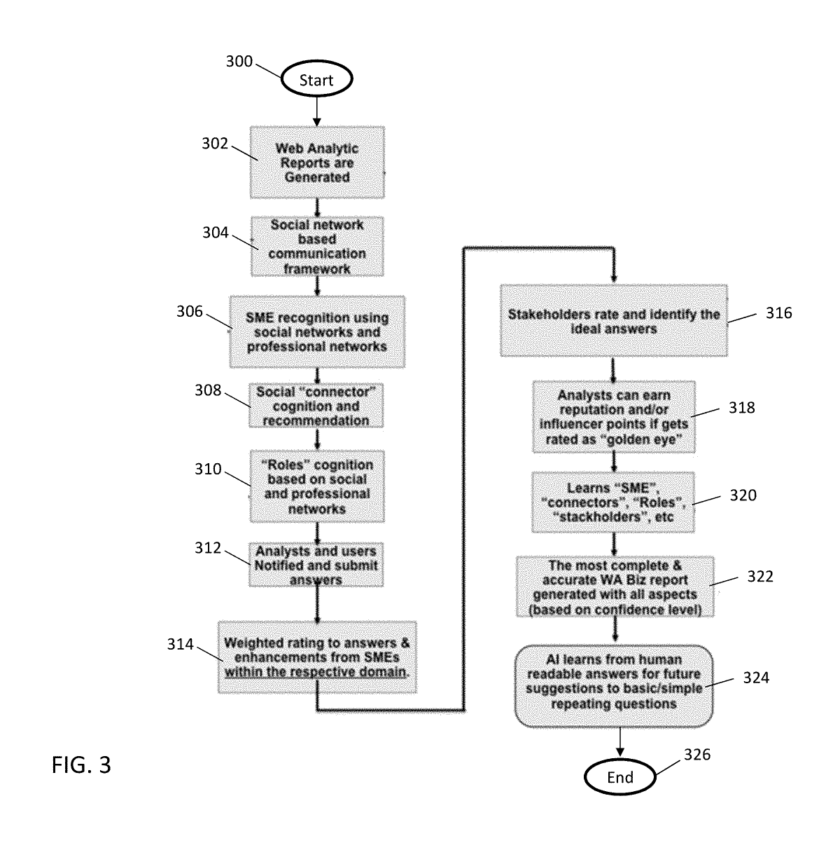

Referring now to FIG. 3, a method of improving the accuracy of a web analytics business report based on SME identification is illustrated according to another non-limiting embodiment. The method begins at operation 300, and at operation 302 and a web analytics report is generated. At operation 304, a social network-based communication framework is generated. At operation 306, one or more users of the system are identified as SMEs based on social network information and/or web page information. At operation 308, one or more connectors are identified. The connectors are capable of identifying one or more entities that are not currently identified as SMEs and/or are not currently using the social networking-based framework but may still provide relevant insights. At operation 310, roles of the users are identified based on social networking information and/or website information. At operation 312, inquiries in connection with the data report are sent to analysists and/or users. At operation 314, ratings are assigned to answers and comments submitted in response to the inquiries.

Turning to operation 316, stakeholders submit ratings to user comments and identify ideal answers that resolve the inquiry. At operation 318, users submitting the ideal answer are assigned scores. These scores may be saved to a user's profile which improves the user's reputation and confidence score. At operation 320, the system actively updates the credibility and roles of one or more SMEs based on the reputation and confidence scores. At operation 322, an updated business report is generated based on the submitted answers and comments. In at least one embodiment, answers/comments are extracted from a chat log and automatically embedded in the generated business report. At operation 324, the answers/comments identified as ideal are extracted from the chat log and stored for future reference, and the method ends at operation 326.

The present invention may be a system, a method, and/or a computer program product at any possible technical detail level of integration. The computer program product may include a computer readable storage medium (or media) having computer readable program instructions thereon for causing a processor to carry out aspects of the present invention.

As used herein, the term “module” refers to an application specific integrated circuit (ASIC), an electronic circuit, an electronic hardware computer processor (shared, dedicated, or group) and memory that executes one or more software or firmware programs, a combinational logic circuit, an electronic hardware controller, a microcontroller and/or other suitable components that provide the described functionality. When implemented in software, a module can be embodied in memory as a non-transitory machine-readable storage medium readable by a processing circuit and storing instructions for execution by the processing circuit for performing a method.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A social networking-based web analytics data processing system having subject matter expert (SME) cognitive capability, comprising:
an electronic computer processor in electrical communication with a social network server that establishes a social network framework and facilitates a chat session including a plurality of users, the computer processor including a data report dashboard module having an electronic hardware controller configured to generate an initial web analytics data report and to generate at least one inquiry associated with at least one abnormality included in the initial web analytics data report, the electronic computer processor including a network dashboard module configured to receive a comment submitted by at least one user among the plurality of users and commands the social network server to display the at least one inquiry in the chat session;
a rating module including an electronic hardware controller configured to detect at least one of a positive ranking and a negative ranking applied to the comment submitted by the at least one user in reply to the at least one inquiry; and
a subject matter expert (SME) identification module including an electronic hardware controller configured to identify a SME based on at least one of social networking information, community expertise ranking and project stakeholder recognitions,
wherein the SME identification module includes an electronic hardware controller that monitors a number of the positive and negative rankings, and dynamically determines at least one user as the SME corresponding to a particular subject-area corresponding to the inquiry based on a number of the positive rankings, and
wherein the network dashboard module generates a signal commanding the social network server to dynamically display a graphical indicator in the chat session that identifies the determined user as the SME,
wherein the SME identification module generates a notification signal that initiates a physical alert on an electronic device of the at least one user indicating that the at least one user is identified as an SME, and updates roles of the at least one user based on a number of positive rankings, the roles determined in response to extracting data from at least one of social network profiles, community profiles and project profiles.

2. The system of claim 1, wherein the system further comprises a skill extractor module configured to the determine roles of the at least one user in response to extracting data from at least one of social network profiles, community profiles and project profiles.

3. (canceled)

4. The system of claim 1, further comprising a rating module including an electronic hardware controller configured to assign a confidence level to the at least one user, the confidence level indicating a probability that user is a SME with respect to the inquiry.

5. The system of claim 4, wherein the comment submitted by the at least one user is identified as an ideal answer when a number of positive rankings exceeds a predetermined threshold.

6. The system of claim 5, wherein the confidence level is based on a number of ideal answers submitted by users associated with the community profiles.

7. The system of claim 4, wherein the data report dashboard module automatically adds the comment submitted by at least one user to the initial web analytics data report when the comment is identified as an ideal answer so as to generate an updated web analytics data report.

8. A method of improving accuracy of a web analytics business report, the method comprising:
executing a chat session among a plurality of users of a social network framework facilitated by an electronic social network server;
generating an initial web analytics data report, and generating at least one inquiry associated with at least one abnormality included in the initial web analytics data report;
receiving a comment submitted by at least one user among the plurality of users and displaying the at least one inquiry in the chat session;
detecting at least one of a positive ranking and a negative ranking applied to a comment submitted by at least one user in reply to the at least one inquiry;
monitoring a number of the positive and negative rankings and dynamically identifying a subject matter expert (SME) among the at least one user based on a number of positive rankings;
dynamically identifying the SME is an expert in a particular subject-area corresponding to the inquiry based on a number of the positive rankings, and displaying a graphical indicator in the chat session that identifies at least one user as the SME;
further comprising initiating a physical alert on an electronic device of the at least one user indicating that the at least one user is identified as an SME, determining roles of the at least one user in response to extracting data from at least one of a social network profile, a community profile and a project profile, and updating the roles of the at least one user based on a number of positive rankings; and
updating the web analytics data report based on an input from the SME to improve the accuracy of the web analytics business report.

9. (canceled)

10. (canceled)

11. The method of claim 8, further comprising assigning a confidence level to the at least one user, the confidence level indicating a probability that the at least one user is a subject matter expert with respect to the inquiry.

12. The method of claim 11, further comprising identifying the comment submitted by the at least one user as an ideal answer when a number of positive rankings exceeds a predetermined threshold.

13. The method of claim 12, wherein the confidence level is based on a number of ideal answers submitted by the at least one user.

14. The method of claim 11, further comprising automatically adding the comment submitted by at least one user to the initial web analytics data report when the comment is identified as an ideal answer so as to generate an updated web analytics data report.

15. A computer program product to control an electronic device to improve accuracy of a web analytics business report, the computer program product comprising a computer readable storage medium having program instructions embodied therewith, the program instructions executable by an electronic computer processor to control the electronic device to perform operations comprising:
monitoring a chat session among a plurality of users of a social network framework facilitated by an electronic social network server;
generating an initial web analytics data report, and generating at least one inquiry associated with at least one abnormality included in the initial web analytics data report;
receiving a comment submitted by at least one user among the plurality of users and displaying the at least one inquiry in the chat session;
detecting at least one of a positive ranking and a negative ranking applied to a comment submitted by at least one user in reply to the at least one inquiry;
monitoring a number of the positive and negative rankings and dynamically identifying a subject matter expert (SME) among the at least one user based on a number of positive rankings;
dynamically identifying the SME is an expert in a particular subject-area corresponding to the inquiry based on a number of the positive rankings, and displaying a graphical indicator in the chat session that identifies at least one user as the SME;
initiating a physical alert on an electronic device of the at least one user indicating that the at least one user is identified as an SME; and
determining roles of the at least one user in response to extracting data from at least one of a social network profile and webpage of the at least one user and updating the roles of the at least one user based on a number of positive rankings.
updating the web analytics data report based on an input from the SME to improve the accuracy of the web analytics business report.

16. (canceled)

17. (canceled)

18. The computer program product of claim 15, further comprising assigning a confidence level to the at least one user, the confidence level indicating a probability that the at least one user is a subject matter expert with respect to the inquiry.

19. The computer program product of claim 18, further comprising identifying the comment submitted by the at least one user as an ideal answer when a number of positive rankings exceeds a predetermined threshold, and wherein the confidence level is based on a number of ideal answers submitted by the at least one user.

20. The computer program product of claim 18, further comprising automatically adding the comment submitted by at least one user to the initial web analytics data report when the comment is identified as an ideal answer so as to generate an updated web analytics data report.
